(19) United States
(12) Patent Application Publication
(10) Pub. No.: US 2026/0355771 A1
(43) Pub. Date: Nov. 12, 2026

(54) Color Changer, Paint Supply Apparatus and Paint Supply System

(71) Applicant: ABB Schweiz AG, Baden (CH)

(72) Inventors: Geir Krogedal, Sandnes (NO); Yngve Finnestad, Sandnes (NO)

(21) Appl. No.: 19/720,100

(22) Filed: Jun. 25, 2026

Related U.S. Application Data
(63) Continuation of application No. PCT/EP2024/050018, filed on Jan. 2, 2024.

(51) Int. Cl. B05B 12/14; B05B 13/04

(52) U.S. Cl. CPC B05B 12/1454; B05B 13/0431

(57) ABSTRACT

A color changer for a paint supply apparatus, the color changer including a primary element including a plurality of port sets, each port set including first and second primary ports; and a secondary element including first and second secondary ports, each for communicating paint with an outlet device. The color changer is configured to dock the primary element and the secondary element in a unique docking position for each port set; wherein for each docking position, the first and second primary ports of the port set associated with the docking position are docked with the respective first and second secondary ports. A paint supply apparatus and a paint supply system are also provided.

### TECHNICAL FIELD

The present disclosure generally relates to color changers. In particular, a color changer for a paint supply apparatus, a paint supply apparatus comprising a color changer, and a paint supply system comprising a paint supply apparatus is provided.

### BACKGROUND

A paint supply apparatus may be used to paint various objects. In one typical implementation, an industrial robot uses such paint supply apparatus to paint motor vehicle body parts. Some paint supply apparatuses comprise an atomizer with which the paint is atomized by a rotating bell cup and applied to the object, e.g., by means of shaping air and electrostatic charging of the paint. Such paint supply apparatuses are inaccurate in terms of paint application. In order to paint a particular shape, the object may be masked with single-use tape and foil.

As an alternative to an atomizer, some paint supply apparatuses comprise an inkjet head including a plurality of nozzles for spraying the paint. Such paint supply apparatuses can provide an accurate painting of complex graphics without overspray and without requiring masking of the object.

EP 4011503 A1 discloses an inkjet coating machine including a robot arm having a chuck at a front end and a nozzle head unit detachably mounted on the chuck. The nozzle head unit includes a nozzle head having a nozzle for spraying the paint, a nozzle control unit for controlling driving of the nozzle, and a head-side circulation path enabling the paint to circulate within the nozzle head. The head-side circulation path includes a head-side supply path and a head-side return path. The robot arm is provided with a color changing valve.

In color changers for use with an inkjet head, paint is not only supplied to the inkjet head, but some paint is also received back from the inkjet head, e.g., to a paint source. To this end, a supply valve module and a return valve module are typically used. The supply valve module comprises a common supply chamber and a plurality of supply valves. By opening one of the supply valves, a paint source of desired color can be brought into communication with the supply path to the inkjet head via the supply chamber. The return valve module comprises a common return chamber and a plurality of return valves. By opening one of the return valves, paint returning from the inkjet head can be returned to a correct paint source via the return line and the return chamber. In color changers of this type, a valve failure has severe consequences. In case an incorrect supply valve is opened, paint mixing will occur and/or an object will be spoiled with an incorrect color. In case an incorrect return valve is opened, a paint source will be spoiled with paint of another color. Incorrect openings of supply and return valves may for example result from programming mistakes or particle accumulation. Color changers of this type are therefore not fail-safe.

### SUMMARY

One object of the invention is to provide an improved color changer.

A further object of the invention is to provide an improved paint supply apparatus.

A still further object of the invention is to provide an improved paint supply system.

These objects are achieved by the color changer, the paint supply apparatus, and the paint supply system, according to the claims.

The invention is based on the realization that by providing a color changer comprising a primary element including a plurality of primary ports and secondary element including at least two secondary ports for fluid communication with an outlet device, where the secondary ports can dock to different port sets of the primary ports, the color changer enables a fail-safe operation.

According to a first aspect, there is provided a color changer for a paint supply apparatus, the color changer comprising a primary element including a plurality of port sets, each port set comprising a first primary port and a second primary port; and a secondary element including a first secondary port and a second secondary port, each for communicating paint with an outlet device. The color changer is configured to dock the primary element and the secondary element in a unique docking position for each port set; wherein for each docking position, the first and second primary ports of the port set associated with the docking position are docked with the respective first and second secondary ports.

By virtue of the unique docking positions, only the primary ports of an intended port set will be docked to the secondary ports while the remaining primary ports of one or more other port sets are undocked from the secondary ports. This makes it physically impossible for paint from an undocked primary port to be supplied to a secondary port and vice versa. For example, when the primary and secondary elements are docked in a first docking position, the primary ports of a first port set are simultaneously docked to the secondary ports while the primary ports of a second port set are undocked from the secondary ports. Conversely, when the primary and secondary elements are docked in a second docking position, different from the first docking position, the primary ports of the second port set are simultaneously docked to the secondary ports while the primary ports of the first port set are undocked from the secondary ports. Thus, the color changer not only guarantees connection of the secondary ports to two primary ports at a time but also guarantees connection to the correct two primary ports at a time.

Due to the undocking of some of the primary ports, a fail-safe barrier is provided between the undocked primary ports and the secondary ports. The operating principles of color changer in terms of physically docking and undocking also makes the performance of the color changer resistant to contamination and wear, for example in comparison with sliding valves. Components of the primary element, such as primary ports thereof, associated with first and second port sets may be referred to first and second sections, respectively, of the primary element.

In order to dock the primary and secondary elements in unique docking positions, either one or both of the primary and secondary elements may be movable to perform a relative movement. The primary element may be movable relatively to the secondary element or the secondary element may be movable relative to the primary element. In order to switch from a first docking position to a second docking position, a switching movement may be performed, e.g., by the primary or secondary element. The switching movement may comprise an undocking movement, which is followed by a repositioning movement, which in turn is followed by a docking movement. The undocking and docking movements may for example be rotational or translational movements. The repositioning movement may comprise a rotational movement and/or a translational movement. After the undocking movement, the primary and secondary elements may be completely separated from each other.

The primary ports may be arranged in a circle on the primary element. In these cases, the repositioning movement may be a rotational movement. Alternatively, the primary ports may be arranged along a line on the primary element. In these cases, the repositioning movement may be a linear movement.

For each pair of primary ports docked with secondary ports, one of the primary and secondary ports may comprise a female part, and the other one of the primary and secondary ports may comprises a male part, entering the female part. When such pair of a primary and secondary port are not docked, the male part does not enter the female part. In these cases, docking and undocking thus imply plugging and unplugging, respectively. For each primary port, the primary port may be associated with only one port set.

For each port set, the color changer may comprise one or more additional primary ports, in addition to the first and second primary ports. Correspondingly, the color changer may comprise one or more additional secondary ports, in addition to the first and second primary ports. Pairs of such additional ports may also be docked simultaneously with the docking of the first and second primary and secondary ports. Such additional ports may for example be used to supply paint, solvent, hardener and/or metallic particles to the secondary element. For example, the secondary element may receive a first paint through the first secondary port and a second paint through the additional secondary port. The first and second paints may then be mixed upstream of the outlet device. Mixed paint returning from the outlet device may then be returned to the primary element through the second secondary port.

For each port set, the first and second primary ports may be arranged to communicate paint with a common paint source. The color changer or the paint supply apparatus may thus comprise a unique paint source associated with each port set. For example, the color changer or the paint supply apparatus may comprise a first paint source associated with a first port set and a second paint source associated with a second port set.

In some alternative variants, each primary port may be arranged to receive paint from a unique paint source. For example, in one port set, the first primary port may be arranged to receive paint from a first paint source, and the second primary port may be arranged to receive paint from a second paint source. In these cases, for a docked port set, a first color can be supplied to the outlet device from the first primary port via the first secondary port, and a second color can be supplied to the outlet device from the second primary port via the second secondary port.

For each port set, the primary element may comprise a primary valve associated with each of the first and second primary ports. Each primary valve may be configured to adopt an open position and a closed position. For example, a first primary valve may be configured to open to establish a fluid communication between a first primary line and the first primary port of the port set, and a second primary valve may be configured to open to establish a fluid communication between a second primary line and the second primary port of the port set.

For each port set, each primary valve may be arranged to open by docking the primary element and the secondary element in the docking position associated with the port set. In these variants, the docking may cause mechanical, pneumatic and/or electric actuation of each primary valve of the port set. Each primary valve of the port set may for example be mechanically actuated to open by docking the primary and secondary elements.

Each port set may include at least one control primary port. The secondary element may include at least one control secondary port. For each docking position, the at least one control secondary port and the at least one control primary port of the port set associated with the docking position may be configured to be docked such that at least one control line for actuating each primary valve associated with the docking position from the secondary element is established.

The at least one control line may be pneumatic. Each control secondary port may for example be connected to a pneumatic source.

In each docking position, a distance of at least 3 mm, such as at least 5 mm, such as at least 10 mm, may be provided between first and second secondary ports and each primary port of the one or more port sets not associated with the docking position.

For each port set, the first and second primary ports may be fixed with respect to each other.

The first and second secondary ports may be fixed with respect to each other.

The color changer may comprise, for each port set, first and second primary lines respectively associated with the first and second primary ports, and a primary interconnecting line interconnecting the first and second primary lines. The primary interconnecting lines enable a service function to be performed on lines associated with one or more undocked port sets at the same time as the secondary ports are docked with primary ports of a docked port set. For example, when primary ports of a first section are docked to the secondary ports, a service operation can be performed on the second section of the primary element. For example, in the second section, solvent and air can be sent from the first primary line, through the first primary interconnecting line and to the second primary line. The second section can also be primed with a new color while the first section is docked to the secondary element.

The primary interconnecting line may be at least partly arranged inside of the primary element.

The first and second secondary ports may be provided in a docking interface. In these cases, the color changer may be configured to perform a relative docking movement between the primary element and the secondary element in a direction transverse to the docking interface to dock the primary element and the secondary element in at least one of the docking positions. The docking movement may for example be at least 1 mm, such as at least 3 mm. In case the repositioning movement comprises a rotational movement, the rotational movement may be a rotation around an axis transverse to the docking interface.

According to a second aspect, there is provided a paint supply apparatus comprising the color changer according to the first aspect, and the outlet device. Each of the first and second secondary ports may be arranged to communicate paint with the outlet device.

The paint supply apparatus may be configured to communicate paint from the first secondary port to the second secondary port through the outlet device.

The outlet device may be an inkjet head comprising a plurality of nozzles.

According to a third aspect, there is provided a paint supply system comprising the paint supply apparatus according to the second aspect and an industrial robot. In these cases, the color changer may be arranged on the industrial robot.

### BRIEF DESCRIPTION OF THE DRAWINGS

Further details, advantages and aspects of the present disclosure will become apparent from the following description taken in conjunction with the drawings, wherein:

FIG. 1: schematically represents a block diagram of a paint supply apparatus comprising a color changer;

FIG. 2: schematically represents a paint supply system comprising an industrial robot and the paint supply apparatus;

FIG. 3: schematically represents a primary element of the color changer;

FIG. 4: schematically represents a secondary element of the color changer;

FIG. 5: schematically represents the color changer in a first docking position;

FIG. 6: schematically represents the color changer in a second docking position;

FIG. 7: schematically represents a perspective view of the color changer;

FIG. 8: schematically represents a block diagram of a color changer according to a further example;

FIG. 9: schematically represents a block diagram of the color changer in FIG. 8 during painting;

FIG. 10: schematically represents a block diagram of the color changer in FIG. 8 during cleaning;

FIG. 11: schematically represents a block diagram of the color changer in FIG. 8 during cleaning according to a further example;

FIG. 12: schematically represents a block diagram of the color changer in FIG. 8 during cleaning according to a further example;

FIG. 13: schematically represents a block diagram of the color changer in FIG. 8 during priming;

FIG. 14: schematically represents a color changer according to a further example;

FIG. 15: schematically represents the color changer in FIG. 14; and

FIG. 16: schematically represents a block diagram of a color changer according to a further example.

### DETAILED DESCRIPTION

In the following, a color changer for a paint supply apparatus, a paint supply apparatus comprising a color changer, and a paint supply system comprising a paint supply apparatus, will be described. The same or similar reference numerals will be used to denote the same or similar structural features.

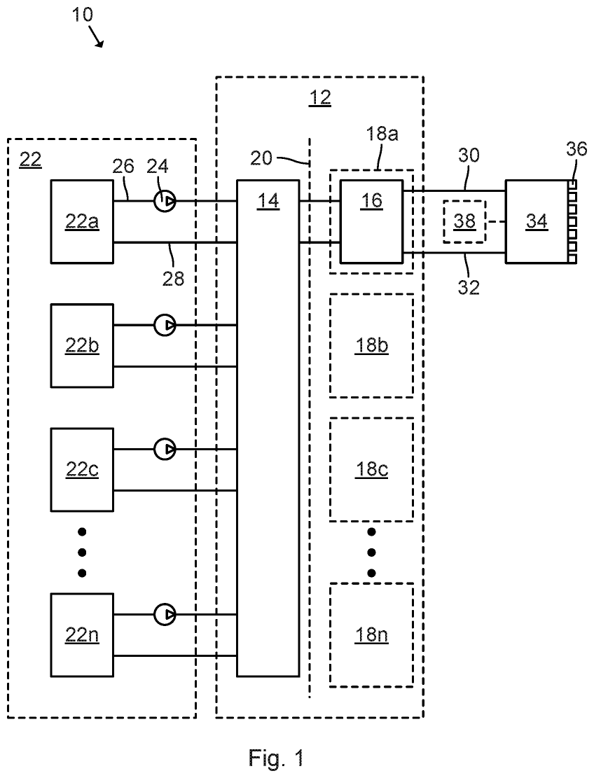

FIG. 1 schematically represents a block diagram of a paint supply apparatus 10. The paint supply apparatus 10 comprises a color changer 12. The color changer 12 comprises a primary element 14 and a secondary element 16. The secondary element 16 can dock to the primary element 14 in a plurality of different docking positions 18a-18n, where n is a positive integer. In FIG. 1, the secondary element 16 is docked to the primary element 14 in a first docking position 18a. FIG. 1 further shows a docking interface 20 between the primary element 14 and the secondary element 16.

The paint supply apparatus 10 of this example further comprises a paint source system 22. The paint source system 22 of this example comprises a paint source 22a-22n for each docking position 18a-18n. The paint sources 22a-22n may for example contain paint with the colors cyan, magenta, yellow, black for full color printing. The paint source system 22 of this example also comprises a pump 24 for each paint source 22a-22n.

The paint supply apparatus 10 of this example further comprises, for each docking position 18a-18n, a first primary line 26 and a second primary line 28. Each primary line 26, 28 provides fluid communication between one of the paint sources 22a-22n and the primary element 14.

The paint supply apparatus 10 of this example further comprises a first secondary line 30, a second secondary line 32 and an outlet device 34, here exemplified as an inkjet head. The outlet device 34 comprises a plurality of nozzles 36. The paint supply apparatus 10 also comprises a nozzle controller 38 for controlling the nozzles 36. In order to circulate paint through the outlet device 34, both secondary lines 30, 32 are needed.

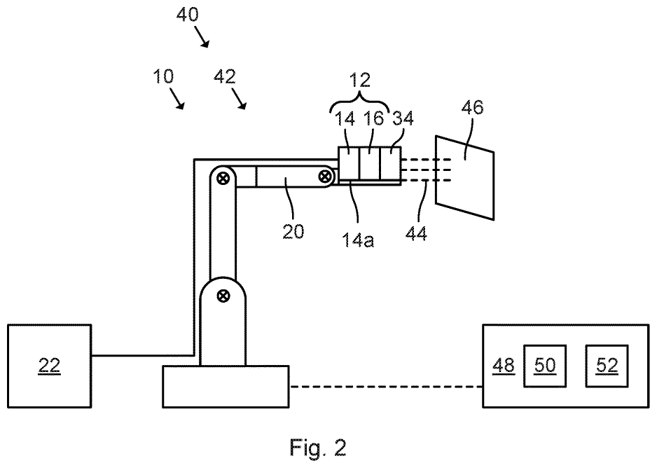

FIG. 2 schematically represents a paint supply system 40 comprising an industrial robot 42 and the paint supply apparatus 10. In this example, the color changer 12 and the outlet device 34 are carried by the industrial robot 42, while the paint source system 22 is not. FIG. 2 also shows that paint 44 is ejected onto an object 46 by the outlet device 34. The object 46 may for example be a vehicle body part.

The paint supply system 40 comprises an electronic control system 48. The control system 48 comprises at least one data processing device 50 and at least one memory 52. The at least one memory 52 has at least one computer program stored therein. The at least one computer program comprises program code which, when executed by the at least one data processing device 50 causes the at least one data processing device 50 to perform, or command performance of, various steps as described herein. The control system 48 may for example control the industrial robot 42, the pumps 24, the nozzle controller 38 and actuation of various valves as described herein.

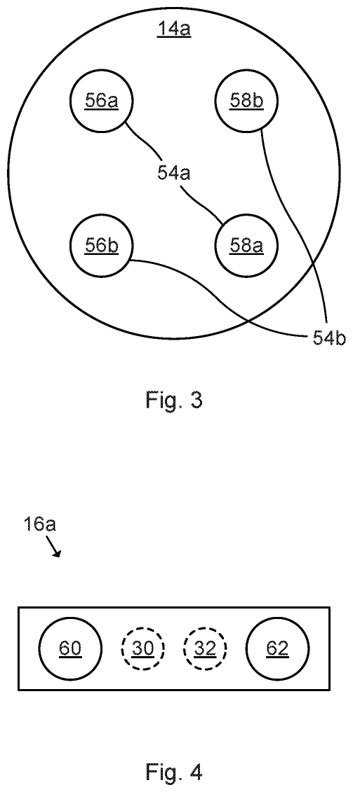

FIG. 3 schematically represents a primary element 14a according to one example. The primary element 14a of this example comprises a first port set 54a and a second port set 54b. The first and second port sets 54a, 54b are here associated with the first and second paint sources 22a, 22b, respectively. The first port set 54a comprises first and second primary ports 56a, 58a. The second port set 54b comprises first and second primary ports 56b, 58b. The primary ports 56a, 56b, 58a, 58b are here arranged in a circle and in a fixed relationship with respect to each other.

FIG. 4 schematically represents a secondary element 16a according to one example. The secondary element 16a comprises first and second secondary ports 60, 62. Sections of the secondary lines 30, 32 are arranged inside of the secondary element 16a. The first secondary port 60 can be brought in fluid communication with the outlet device 34 via the first secondary line 30. The second secondary port 62 can be brought in fluid communication with the outlet device 34 via the second secondary line 32. The secondary element 16a of this example is rigid. That is, the first and second secondary ports 60, 62 are fixed with respect to each other and the secondary element 16a does not comprise any degree of freedom between the first and second secondary ports 60, 62. Moreover, the secondary element 16a of this example is elongated.

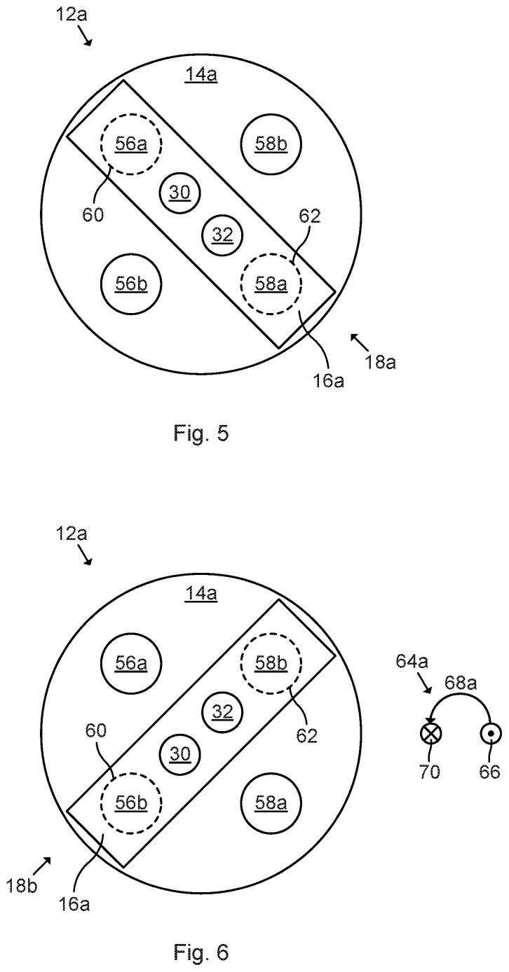

FIG. 5 schematically represents the color changer 12a in the first docking position 18a. In the first docking position 18a, the secondary element 16a is docked to the primary element 14a such that the first secondary port 60 is docked to the first primary port 56a and the second secondary port 62 is docked to the second primary port 58a. Paint 44 can thereby be supplied from the first paint source 22a, through the first primary line 26 associated with the first docking position 18a, through the first primary port 56a, through the first secondary port 60, through the first secondary line 30, through the outlet device 34, through the second secondary line 32, through the second secondary port 62, through the second primary port 58a, through the second primary line 28 associated with the first docking position 18a and back to the first paint source 22a. In the first docking position 18a, each of the primary ports 56b, 58b of the second port set 54b, associated with the second paint source 22b, is undocked from the secondary element 16a.

FIG. 6 schematically represents the color changer 12a in a second docking position 18b. In the second docking position 18b, the secondary element 16a is docked to the primary element 14a such that the first secondary port 60 is docked to the first primary port 56b and the second secondary port 62 is docked to the second primary port 58b. Paint 44 can thereby be supplied from the second paint source 22b, through the first primary line 26 associated with the second docking position 18b, through the first primary port 56b, through the first secondary port 60, through the first secondary line 30, through the outlet device 34, through the second secondary line 32, through the second secondary port 62, through the second primary port 58b, through the second primary line 28 associated with the second docking position 18b and back to the second paint source 22b. In the second docking position 18b, each of the primary ports 56a, 58a of the first port set 54a associated with the first paint source 22a, is undocked from the secondary element 16a. Thus, each docking position 18a, 18b is associated with a unique port set 54a, 54b. The color changer 12a provides a completely fail-safe layout and reliably ensures that no paint mixing occurs.

FIG. 6 further shows one example of a switching movement 64a of the secondary element 16a when switching from the first docking position 18a to the second docking position 18b. The switching movement 64a here comprises a linear undocking movement 66, followed by a rotational repositioning movement 68a, followed by a linear docking movement 70.

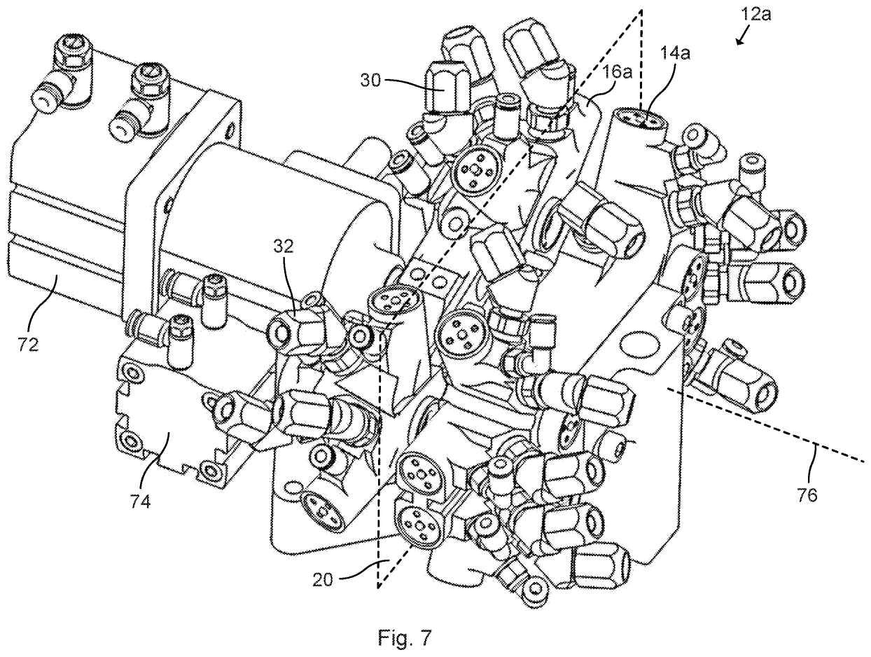

FIG. 7 schematically represents a perspective view of the color changer 12a according to one specific implementation. In FIG. 7, it is shown that the color changer 12a comprises a rotation motor 72 and a translation motor 74. By driving the rotation motor 72, the secondary element 16a can be rotated relative to the primary element 14a around a rotation axis 76, e.g., to perform the repositioning movement 68a. By driving the translation motor 74, the secondary element 16a can be moved linearly relative to the primary element 14a along the rotation axis 76, e.g., to perform the undocking movement 66 and the docking movement 70. The rotation motor 72 and the translation motor 74 may for example be step motors. The rotation motor 72 and the translation motor 74 may be controlled by the control system 48.

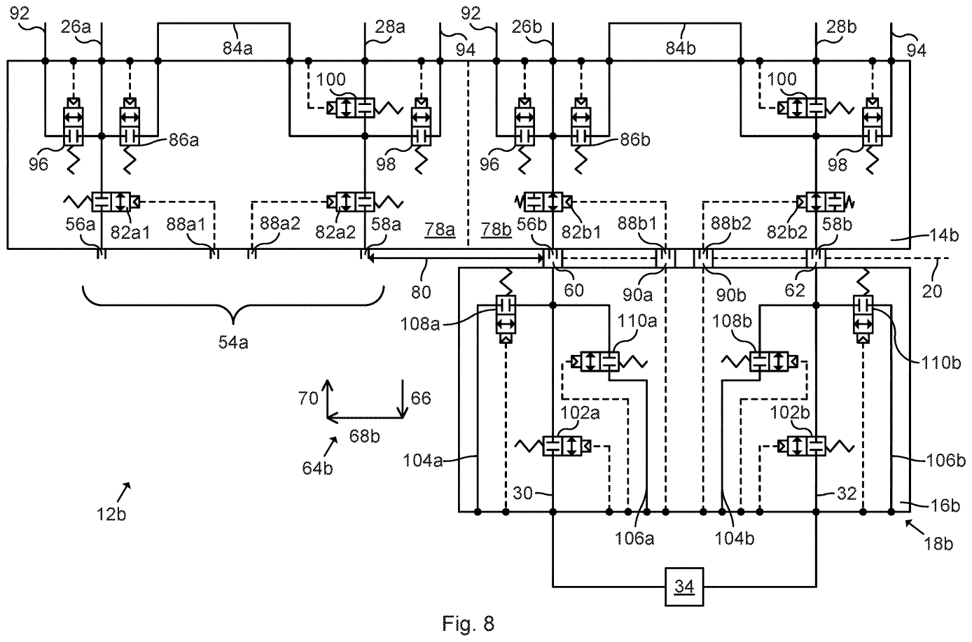

FIG. 8 schematically represents a block diagram of a color changer 12b according to a further example. The color changer 12b comprises a primary element 14b and a secondary element 16b. The color changer 12b differs from the color changer 12a by the layout of the primary ports 56a, 58a, 56b, 58b. In this specific and non-limiting example of the color changer 12b, the primary ports 56a, 58a, 56b, 58b are arranged along a straight line. In this example, each of the primary ports 56a, 58a, 56b, 58b comprises a male part and each of the secondary ports 60, 62 comprises a corresponding female part, each for being docked with a corresponding male part.

Moreover, the color changer 12b differs from the color changer 12a in that the color changer 12b is linearly movable between the docking positions 18a, 18b. In FIG. 8, the color changer 12b is shown in the second docking position 18b. In order to switch from the second docking position 18b to the first docking position 18a, the secondary element 16b is controlled to perform a switching movement 64b comprising the undocking movement 66, followed by a linear repositioning movement 68b, followed by the docking movement 70. To this end, the rotation motor 72 may be arranged to accomplish a linear movement instead of a rotational movement, e.g., by using a suitable transmission. As shown in FIG. 8, the undocking movement 66 and the docking movement 70 are here transverse to the docking interface 20, and the repositioning movement 68b is parallel with the docking interface 20.

FIG. 8 shows a first section 78a and a second section 78b of the primary element 14b. The first section 78a is associated with the first port set 54a and the first docking position 18a. The second section 78b is associated with the second port set 54b and the second docking position 18b. The sections 78a and 78b are identic in this example. Thus, any structural description given in connection with one of the sections 78a, 78b also applies to the other of the sections 78a, 78b.

In the second docking position 18b, the first and second secondary ports 60, 62 are undocked from the first and second primary ports 56a, 58a of the first port set 54a. A distance 80 of at least 3 mm is formed between the first secondary port 60 and the second primary port 58a of the first port set 54a. Corresponding distances between the first secondary port 60 and the first primary port 56a of the first port set 54a, and between the second secondary port 62 and any of the primary ports 56a, 58a of the first port set 54a, are larger. Fail-safe barriers are thereby provided between the undocked primary ports 56a, 58a and the secondary ports 60, 62.

The first section 78a comprises first and second primary lines 26a, 28a connected to the first paint source 22a. The first section 78a further comprises a first primary valve 82a1 arranged on the first primary line 26a next to the first primary port 56a, and a second primary valve 82a2 arranged on the second primary line 28a next to the second primary port 58a.

The first section 78a further comprises a first interconnecting line 84a interconnecting the first and second primary lines 26a, 28a. The first interconnecting line 84a connects to each of the primary lines 26a, 28a inside of the primary element 14b. The first interconnecting line 84a of this example, however, also extends outside of the primary element 14b. The first section 78a further comprises a first interconnecting valve 86a arranged on the first interconnecting line 84a. The first section 78a further comprises first and second control primary ports 88a1, 88a2, respectively associated with the first and second primary valves 82a1, 82a2.

Correspondingly, the second section 78b comprises first and second primary lines 26b, 28b connected to the second paint source 22b. The second section 78b further comprises a first primary valve 82b1 arranged on the first primary line 26b next to the first primary port 56b, and a second primary valve 82b2 arranged on the second primary line 28b next to the second primary port 58b.

The second section 78b further comprises a second interconnecting line 84b interconnecting the first and second primary lines 26b, 28b. The second interconnecting line 84b connects to each of the primary lines 26b, 28b inside of the primary element 14b. The second interconnecting line 84b of this example, however, also extends outside of the primary element 14b. The second section 78b further comprises a second interconnecting valve 86b arranged on the first interconnecting line 84a. The second section 78b further comprises first and second control primary ports 88b1, 88b2 respectively associated with the first and second primary valves 82b1, 82b2.

The secondary element 16b of this example comprises first and second control secondary ports 90a, 90b. In this example, each of the control secondary ports 90a, 90b is connected to a pneumatic source (not shown). In FIG. 8, dashed lines represent lines for pneumatic pilot pressure. As shown in FIG. 8, all of the secondary ports 60, 62 and the control secondary ports 90a, 90b are provided in the docking interface 20.

For each of the first and second docking positions 18a, 18b, the primary element 14b of this example further comprises a primary cleaning line 92, a primary dump line 94, a primary cleaning valve 96, a primary dump valve 98, and a primary auxiliary valve 100. The primary cleaning lines 92 each connects a cleaning source (not shown) to the respective first primary lines 26a, 26b. The primary cleaning valves 96 are provided on the respective primary cleaning lines 92. The primary dump lines 94 each connect the respective second primary lines 28a, 28b to a dump location (not shown). The primary dump valves 98 are provided on the respective primary dump lines 94.

In the first section 78a, the primary auxiliary valve 100 is provided on the second primary line 28a such that a junction between the second primary line 28a, the first interconnecting line 84a and the primary dump line 94 is positioned between the primary auxiliary valve 100 and the second primary valve 82a2. Correspondingly, in the second section 78b, the primary auxiliary valve 100 is provided on the second primary line 28b such that a junction between the second primary line 28b, the second interconnecting line 84b and the primary dump line 94 is positioned between the primary auxiliary valve 100 and the second primary valve 82b2.

The secondary element 16b of this example further comprises first and second secondary valves 102a, 102b, first and second secondary cleaning lines 104a, 104b, first and second secondary dump lines 106a, 106b, first and second secondary cleaning valves 108a, 108b, and first and second secondary dump valves 110a, 110b. The first and second secondary valves 102a, 102b are respectively provided on the first and second secondary lines 30, 32. The first and second secondary cleaning valves 108a, 108 are respectively provided on the first and second secondary cleaning lines 104a, 104b. The first and second secondary dump valves 110a, 110b are respectively provided on the first and second secondary dump lines 106a, 106b.

In this specific and non-limiting example, each valve 82a1, 82ab, 82b1, 82b2, 86a, 86b, 96, 98, 100, 102a, 102b, 108a, 108b, 110a, 110b is a pneumatically actuated 2/2 valve (two ports and two positions).

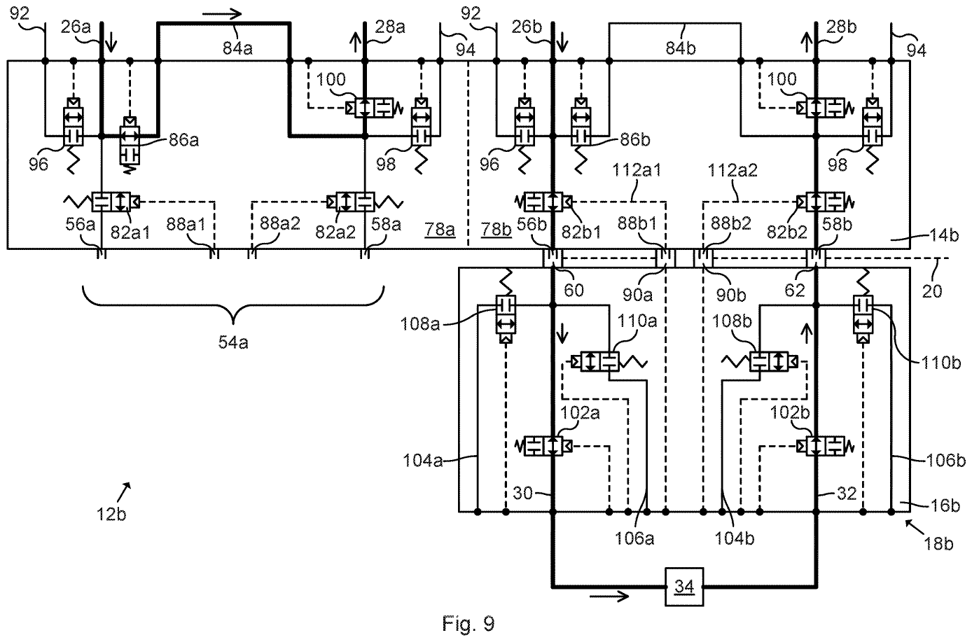

FIG. 9 schematically represents a block diagram of the color changer 12b during painting. When the secondary element 16b docks to the primary element 14b in the second docking position 18b, the first and second secondary ports 60, 62 respectively dock to the first and second primary ports 56b, 58b, and the first and second control secondary ports 90a, 90b respectively dock to the first and second control primary ports 88b1, 88b2. Thereby, a first control line 112a1 for pneumatically actuating the first primary valve 82b1 from the secondary element 16b, and a second control line 112b1 for pneumatically actuating the second primary valve 82b2 from the secondary element 16b, are established. The first and second primary valves 82b1, 82b2 of the second section 78b are thereby caused to open only when the secondary element 16b is docked to the primary element 14b in the second docking position 18b. By controlling also the first and second secondary valves 102a, 102b to open, paint 44 is led from the second paint source 22b, through the first primary line 26b, through the first primary port 56b, through the first secondary port 60, through the first secondary line 30 and to the outlet device 34, and paint 44 is led back from the outlet device 34, through the second secondary line 32, through the second secondary port 62, through the second primary port 58b, through the second primary line 28b and back to the second paint source 22b. The secondary element 16a thus provides a paint flow in two directions, both to the outlet device 34 and from the outlet device 34.

As shown in FIG. 9, the secondary ports 60 and 62 are completely separated from the first port set 54a in the second docking position 18b and any cross-contamination is prevented. If for example any of the valves 82a1, 82a2 of the first section 78a should fail, paint will not be transferred into the secondary element 16b. In this case, paint will in a worst case be ejected on the color changer 12b, but not on the object 46.

At the same time, i.e., while the secondary element 16b is docked to the primary element 14b in the second docking position 18b, the first interconnecting valve 86a and the primary auxiliary valve 100 are controlled to open such that the paint 44 can circulate from the first paint source 22a through the first primary line 26a, through the first interconnecting line 84a, through the second primary line 28a and back to the first paint source 22a.

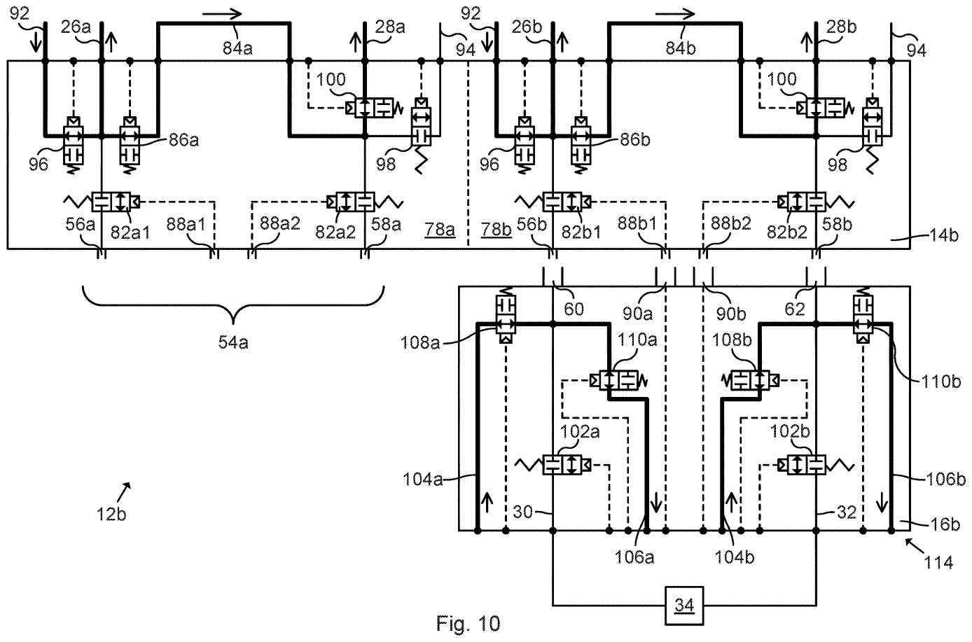

FIG. 10 schematically represents a block diagram of the color changer 12b during cleaning according to one example. In FIG. 10, the secondary element 16b is in an undocking position 114. Moreover, the first and second sections 78a, 78b have been respectively disconnected from the first and second paint sources 22a, 22b. In the first section 78a, solvent and air are alternatingly supplied to the primary cleaning line 92, the first and second primary lines 26a, 28a and the first interconnecting line 84a by opening the primary cleaning valve 96, the first interconnecting valve 86a and the primary auxiliary valve 100. Correspondingly, in the second section 78b, solvent and air are alternatingly supplied to the primary cleaning line 92, the first and second primary lines 26b, 28b and the second interconnecting line 84b by opening the primary cleaning valve 96, the second interconnecting valve 86b and the primary auxiliary valve 100. In the secondary element 16b, solvent and air are alternatingly supplied to the first and second secondary cleaning lines 104a, 104b, respectively, and led out through the secondary dump lines 106a, 106b, respectively, by opening the first and second secondary cleaning valves 108a, 108b, and opening the first and second secondary dump valves 110a, 110b.

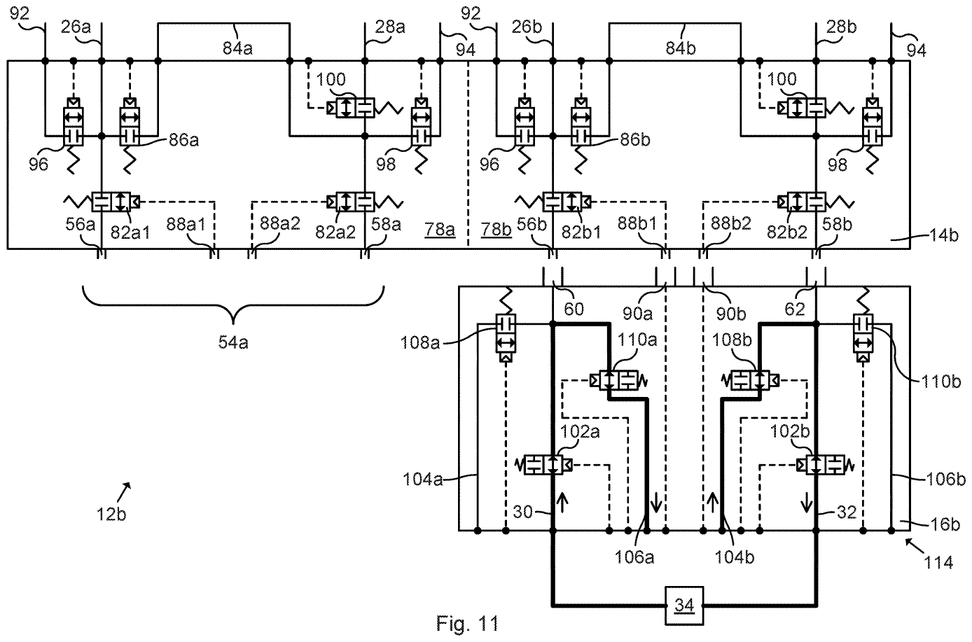

FIG. 11 schematically represents a block diagram of the color changer 12b during cleaning according to a further example. In FIG. 11, first secondary cleaning valve 108a and the second secondary dump valve 110b are controlled to close and the second secondary cleaning valve 108b, the second secondary valve 102b, the first secondary valve 102a and the second secondary dump valve 110a are controlled to open while solvent and air are alternatingly supplied to the secondary cleaning line 104b, through the second secondary line 32, through the outlet device 34, through the first secondary line 30 and through the first secondary dump line 106a.

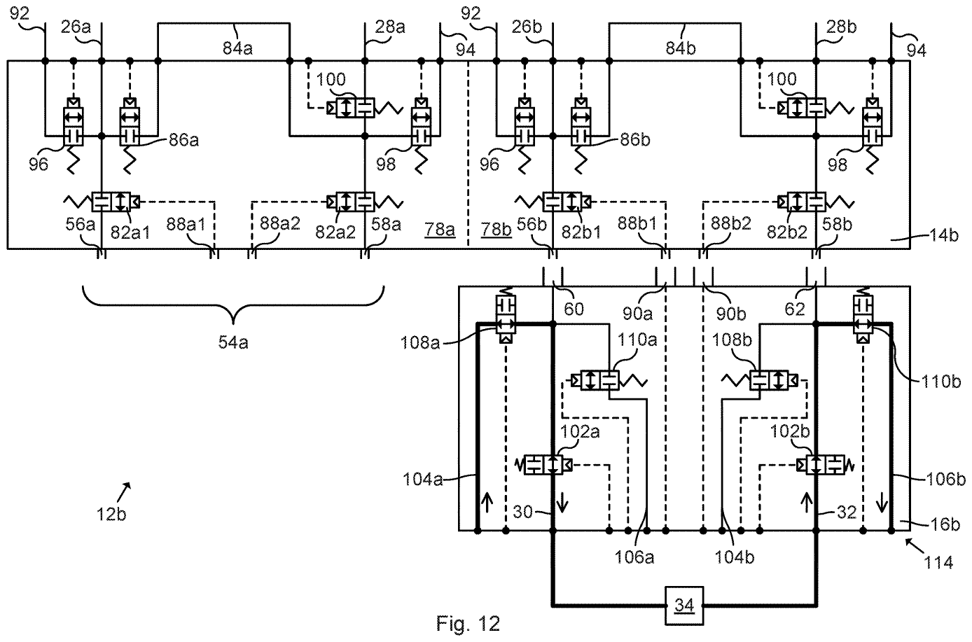

FIG. 12 schematically represents a block diagram of the color changer 12b during cleaning according to a further example. In FIG. 12, the first secondary dump valve 110a and the second secondary cleaning valve 108b are controlled to close and the first secondary cleaning valve 108a, the first secondary valve 102a, the second secondary valve 102b and the second secondary dump valve 110b are controlled to open while solvent and air are alternatingly supplied to the first secondary cleaning line 104a, through the first secondary line 30, through the outlet device 34, through the second secondary line 32 and through the second secondary dump line 106b.

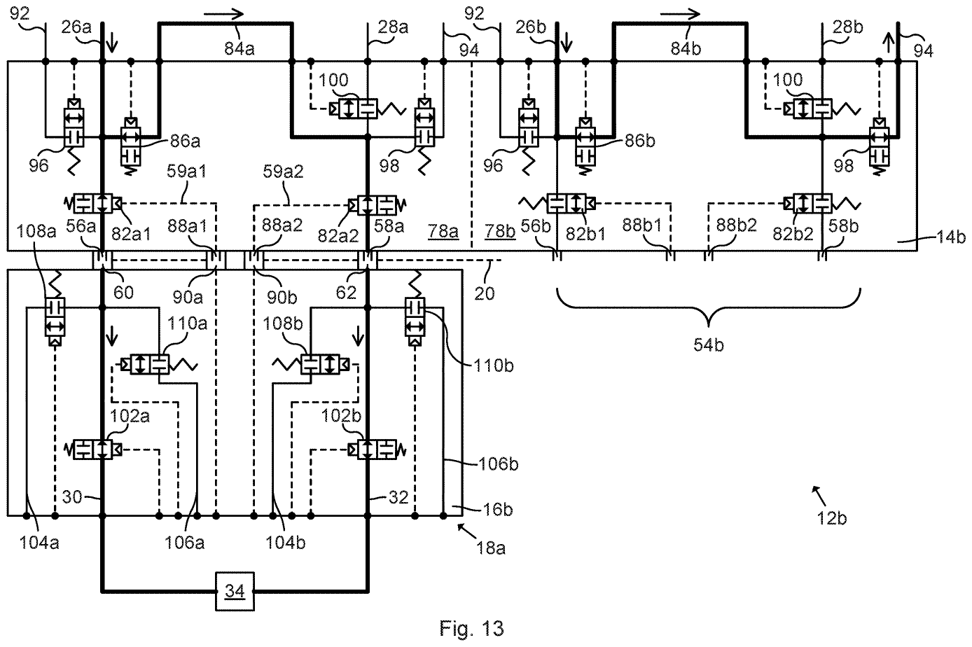

FIG. 13 schematically represents a block diagram of the color changer 12b during priming. In FIG. 13, the secondary element 16b has docked to the primary element 14b in the first docking position 18a causing the first and second primary valves 82a1 and 82a2 to open. The first section 78a, the secondary element 16b and the outlet device 34 are primed with a new color by additionally controlling the first interconnecting valve 86a, the first secondary valve 102a and second secondary valve 102b to open. The second section 78b is primed with a new color by controlling the second interconnecting valve 86b and the primary dump valve 98 to open. As can be gathered from FIGS. 10 and 13, the color changer 12b enables cleaning and priming of one of the sections 78a and 78b while the secondary element 16b is docked to another one of the sections 78a and 78b.

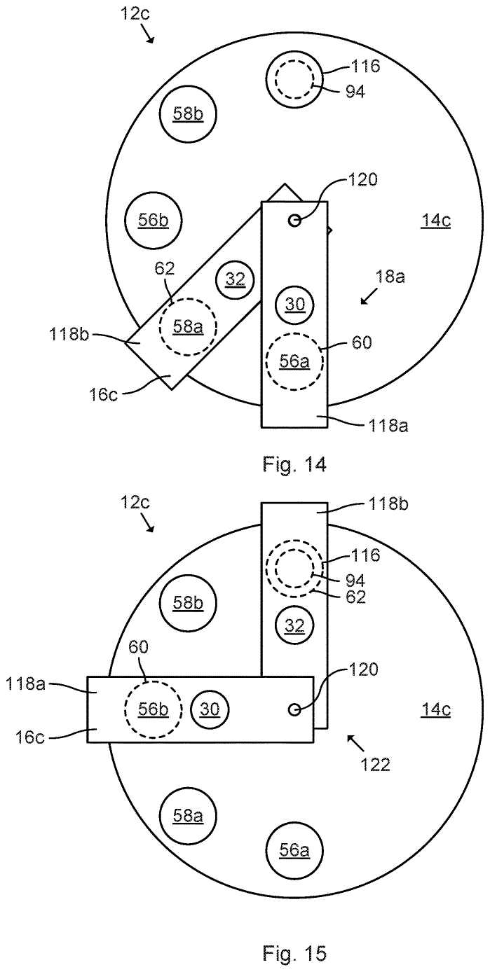

FIG. 14 schematically represents a color changer 12c according to a further example. Mainly differences with respect to the color changers 12a and 12b will be described. The color changer 12c comprises a primary element 14c and a secondary element 16c. In addition to the primary ports 56a, 56b, 58a, 58b, the primary element 14c also comprises a dump primary port 116 for direct connection to the primary dump line 94.

The secondary element 16c of this example comprises a first secondary member 118a and a second secondary member 118b. The first and second secondary members 118a, 118b are movable relative to each other, here rotatable relative to each other around a pivot 120. Moreover, the first and second secondary members 118a, 118b are here exemplified as arms. The first secondary member 118a comprises the first secondary port 60 and a part of the first secondary line 30. The second secondary member 118b comprises the second secondary port 62 and a part of the second secondary line 32. In FIG. 14, the secondary element 16c is in the first docking position 18a such that the first secondary port 60 docks with the first primary port 56a and the second secondary port 62 docks with the second primary port 58a.

FIG. 15 schematically represents the color changer 12c in FIG. 14. In FIG. 15, the secondary element 16c is in a dumping position 122. In the dumping position 122 of this example, the first secondary port 60 is docked to the first primary port 56b and the second secondary port 62 is docked to the dump primary port 116.

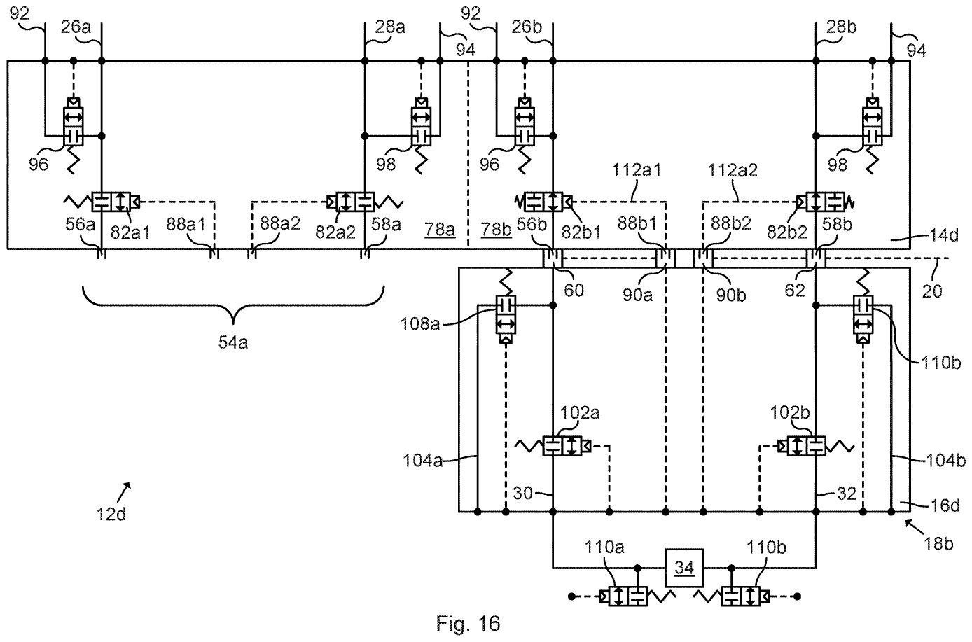

FIG. 16 schematically represents a block diagram of a color changer 12d according to a further example. Mainly differences with respect to the color changer 12b will be described. The color changer 12d comprises a primary element 14d and a secondary element 16d.

In the color changer 12d, each of the primary lines 26a, 28a, 26b, 28b can be connected to a unique paint source 22a-22n. Thus, the color changer 12d may be simultaneously connected to four paint sources 22a-22n. When the secondary element 16d is docked to the primary element 14d in the second docking position 18b, a first color can be supplied to the outlet device 34 via the first primary line 26b, the first primary port 56b, the first secondary port 60 and the first secondary line 30 by controlling the first secondary valve 102a to open, and a second color can be supplied to the outlet device 34 via the second primary line 28b, the second primary port 58b, the second secondary port 62 and the second secondary line 32 by controlling the second secondary valve 102b to open. In this case, the outlet device 34 may be an atomizer instead of an inkjet head.

In the secondary element 16d of this example, the first secondary dump valve 110a is positioned on the first secondary line 30 between the first secondary valve 102a and the outlet device 34, and the second secondary dump valve 110b is positioned on the second secondary line 32 between the second secondary valve 102b and the outlet device 34. The primary element 14d of this example does not comprise the first and second interconnecting lines 84a, 84b of the examples of FIGS. 8 to 13.

Each color changer 12a-12d may be used as the color changer 12 in the paint supply apparatus 10. One, several or all of the color changers 12a-12d, may also be referred to with reference numeral “12”. One, several or all of the primary elements 14a-14d may also be referred to with reference numeral “14”. One, several or all of the secondary elements 16a-16d, may also be referred to with reference numeral “16”.

While the present disclosure has been described with reference to exemplary embodiments, it will be appreciated that the present invention is not limited to what has been described above. For example, it will be appreciated that the dimensions of the parts may be varied as needed. Accordingly, it is intended that the present invention may be limited only by the scope of the claims appended hereto.

1. A color changer for a paint supply apparatus, the color changer comprising:
a primary element including a plurality of port sets, each port set including a first primary port and a second primary port; and
a secondary element including a first secondary port and a second secondary port, each for communicating paint with an outlet device;
wherein the color changer is configured to dock the primary element and the secondary element in a unique docking position for each port set; wherein for each docking position, the first and second primary ports of the port set associated with the docking position are docked with the respective first and second secondary ports.

2. The color changer according to claim 1, wherein, for each port set, the primary element includes a primary valve associated with each of the first and second primary ports.

3. The color changer according to claim 2, wherein for each port set, each primary valve is arranged to open by docking the primary element and the secondary element in the docking position associated with the port set.

4. The color changer according to claim 2, wherein each port set includes at least one control primary port, wherein the secondary element includes at least one control secondary port, and wherein for each docking position, the at least one control secondary port and the at least one control primary port of the port set associated with the docking position are configured to dock such that at least one control line for actuating each primary valve associated with the docking position from the secondary element is established.

5. The color changer according to claim 4, wherein the at least one control line is pneumatic.

6. The color changer according to claim 1, wherein in each docking position, a distance of at least 3 mm is provided between the first and second secondary ports and each primary port of the one or more port sets not associated with the docking position.

7. The color changer according to claim 1, wherein for each port set, the first and second primary ports are fixed with respect to each other.

8. The color changer according to claim 1, wherein the first and second secondary ports are fixed with respect to each other.

9. The color changer according to claim 1, wherein the color changer comprises, for each port set, first and second primary lines respectively associated with the first and second primary ports, and a primary interconnecting line interconnecting the first and second primary lines.

10. The color changer according to claim 9, wherein the primary interconnecting line is at least partly arranged inside of the primary element.

11. The color changer according to claim 1, wherein the first and second secondary ports are provided in a docking interface, and wherein the color changer is configured to perform a relative docking movement between the primary element and the secondary element in a direction transverse to the docking interface to dock the primary element and the secondary element in at least one of the docking positions.

12. A paint supply apparatus comprising the color changer including:
a primary element including a plurality of port sets, each port set including a first primary port and a second primary port; and
a secondary element including a first secondary port and a second secondary port, each for communicating paint with an outlet device;
wherein the color changer is configured to dock the primary element and the secondary element in a unique docking position for each port set; wherein for each docking position, the first and second primary ports of the port set associated with the docking position are docked with the respective first and second secondary ports, and the outlet device, wherein each of the first and second secondary ports is arranged to communicate paint with the outlet device.

13. The paint supply apparatus according to claim 12, wherein the paint supply apparatus is configured to communicate paint from the first secondary port to the second secondary port through the outlet device.

14. The paint supply apparatus according to claim 13, wherein the outlet device is an inkjet head including a plurality of nozzles.

15. A paint supply system comprising the paint supply apparatus including:
a primary element including a plurality of port sets, each port set including a first primary port and a second primary port; and
a secondary element including a first secondary port and a second secondary port, each for communicating paint with an outlet device;
wherein the color changer is configured to dock the primary element and the secondary element in a unique docking position for each port set; wherein for each docking position, the first and second primary ports of the port set associated with the docking position are docked with the respective first and second secondary ports, and the outlet device, wherein each of the first and second secondary ports is arranged to communicate paint with the outlet device, and
an industrial robot, wherein the color changer is arranged on the industrial robot.

16. The color changer according to claim 3, wherein each port set includes at least one control primary port, wherein the secondary element includes at least one control secondary port, and wherein for each docking position, the at least one control secondary port and the at least one control primary port of the port set associated with the docking position are configured to dock such that at least one control line for actuating each primary valve associated with the docking position from the secondary element is established.

17. The color changer according to claim 2, wherein in each docking position, a distance of at least 3 mm is provided between the first and second secondary ports and each primary port of the one or more port sets not associated with the docking position.

18. The color changer according to claim 2, wherein for each port set, the first and second primary ports are fixed with respect to each other.

19. The color changer according to claim 2, wherein the first and second secondary ports are fixed with respect to each other.

20. The color changer according to claim 2, wherein the color changer comprises, for each port set, first and second primary lines respectively associated with the first and second primary ports, and a primary interconnecting line interconnecting the first and second primary lines.
